(19) United States
(12) Patent Application Publication
(10) Pub. No.: US 2016/0223151 A1
(43) Pub. Date: Aug. 4, 2016

(54) LIGHT EMITTING DIODE RAIL AND LIGHT CURING APPARATUS COMPRISING SAME

(71) Applicant: SAMSUNG DISPLAY CO., LTD., Yongin-City (KR)

(72) Inventors: Chul Hyun CHOI, Yongin-si (KR); Dong Jin SEO, Seoul (KR); Sung Woo CHO, Suwon-si (KR)

(21) Appl. No.: 14/802,007

(22) Filed: Jul. 17, 2015

(30) Foreign Application Priority Data
Feb. 4, 2015 (KR) 10-2015-0017561

(51) Int. Cl. F21S 4/28; F21V 19/00; F21V 19/02; F21V 23/06

(52) U.S. Cl. CPC F21S 4/28; F21V 23/06; F21V 19/0015; F21V 19/02; F21Y 2103/003

(57) ABSTRACT

A light emitting diode (LED) rail includes a rail body, a first electrode and a second electrode within the rail body, and a plurality of LEDs in the rail body and electrically connected to the first electrode and the second electrode. The LEDs include a first lead frame and a second lead frame. The first lead frame and the second lead frame slidably contact the first electrode and the second electrode, respectively.

### CROSS-REFERENCE TO RELATED APPLICATION

Korean Patent Application No. 10-2015-0017561, filed on Feb. 4, 2015, and entitled, “Light Emitting Diode Rail and Light Curing Apparatus Comprising Same,” is incorporated by reference herein in its entirety.

### BACKGROUND

1. Field

One or more embodiments described herein relate to a light emitting diode rail and a light curing apparatus including a light emitting diode rail.

2. Description of the Related Art

Light emitting diodes (LEDs) consume less power and are smaller and lighter than other types of light generating devices. Also, LEDs may emit light in a specific wavelength range. For example, one type of LED emits light having an ultra short wavelength in the ultraviolet range beyond short wavelength blue light.

### SUMMARY

In accordance with one or more embodiments, a light emitting diode (LED) rail includes a rail body; a first electrode and a second electrode within the rail body; and a plurality of LEDs in the rail body and electrically connected to the first electrode and the second electrode, wherein the LEDs include a first lead frame and a second lead frame and wherein the first lead frame and the second lead frame slidably contact the first electrode and the second electrode, respectively.

The rail body may include a lower plate, and upper lids extending toward a center position above the lower plate, the upper lids extending from respective ends of the lower plate, the upper lids spaced to form a slit substantially at the center position above the lower plate. The LEDs may be supported by the lower plate and the upper lids of the rail body and are guided by the rail body, and the LEDs may move in a lengthwise direction of the LED rail. The LEDs may move in the lengthwise direction of the LED rail while maintaining an electrical connection between the first electrode and the first lead frame and an electrical connection between the second electrode and the second lead frame. The LEDs may emit light in an ultraviolet range.

The first electrode and the second electrode may be at respective sides of the rail body in a width direction of the rail body and may extend in a lengthwise direction of the rail body. The LEDs may be electrically connected to the first electrode and the second electrode in parallel with each other.

In accordance with one or more other embodiments, a light emitting device (LED) rail includes a rail body; a first electrode and a second electrode within the rail body; a plurality of LED supports in the rail body and electrically connected to the first electrode and the second electrode: and a plurality of LEDs on respective ones of the LED supports and inserted in the rail body, wherein the LEDs include a first lead frame and a second lead frame, wherein the LED supports include a first connecting conductive wire and a second connecting conductive wire, and wherein the first lead frame slidably contacts the first electrode through the first connecting conductive wire and the second lead frame slidably contacts the second electrode through the second connecting conductive wire.

The rail body may include a lower plate, side walls at respective ends of the lower plate, and upper lids extending from respective ones of the sidewalls toward a center position above the lower plate, the upper lids spaced to form a slit substantially at the center position above the lower plate. The LEDs and the LED supports may be guided by the rail body and wherein the LEDs and the LED supports are to move in a lengthwise direction of the LED rail.

The LEDs and the LED supports may move in the lengthwise direction of the LED rail while an electrical connection is maintained between the first electrode and the first connecting conductive wire and an electrical connection is maintained between the second electrode and the second connecting conductive wire.

The first connecting conductive wire and the second connecting conductive wire may protrude outwardly after penetrating through respective side walls of a support body, and each of the first connecting conductive wire and the second connecting conductive wire may be curved to have a bent shape. The first electrode and the second electrode may be at respective side walls of the rail body facing each other and may extend in a lengthwise direction of the rail body. The LEDs may emit light in an ultraviolet range.

In accordance with one or more other embodiments, a light curing apparatus includes a plurality of light emitting devices (LEDs); and one or more LED rails, wherein the one or more LED rails include the LEDs and wherein the LEDs are to move in a lengthwise direction of the LED rails. The one or more LEDs may be removably mounted in each of the one or more LED rails. The one or more LEDs in each of the LED rails may change position to accommodate an additional LED. The LED rails may move to a position adjacent to at least one side of an object to be light-cured, and the position may be based on a size of the object to be light-cured.

### BRIEF DESCRIPTION OF THE DRAWINGS

Features will become apparent to those of skill in the art by describing in detail exemplary embodiments with reference to the attached drawings in which:

FIG. 1 illustrates an embodiment of a light curing apparatus;

FIG. 2 illustrates an embodiment of an LED rail in FIG. 1;

FIG. 3 illustrates a view of the LED rail along section line in FIG. 2;

FIG. 4 illustrates another view of the light curing apparatus;

FIG. 5 illustrates another view of the light curing apparatus;

FIG. 6 illustrates the light curing apparatus with a different arrangement of LED rails;

FIG. 7 illustrates the light curing apparatus with a different spacing between LEDs;

FIG. 8 illustrates another embodiment of an LED rail; and

FIG. 9 illustrates another embodiment of an LED rail.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

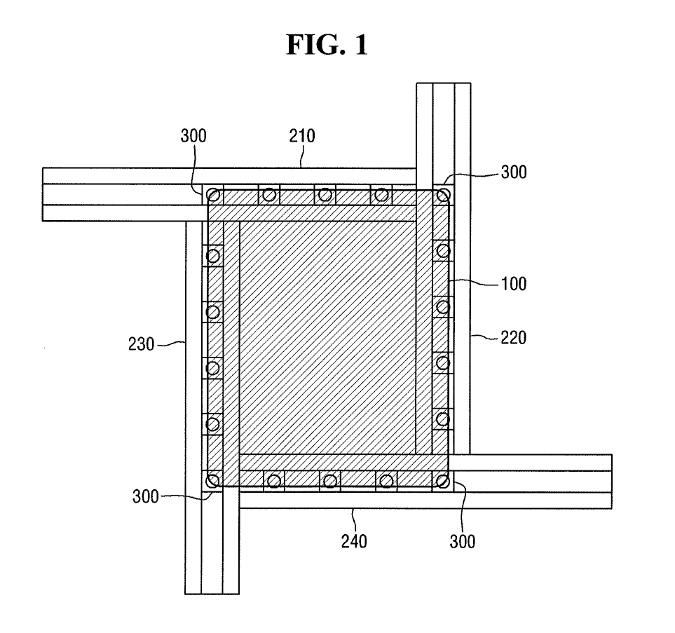

FIG. 1 illustrates an embodiment of a light curing apparatus which includes a first LED rail 210, a second LED rail 220, a third LED rail 230 and a fourth LED rail 240. A window panel 100 is an example of an object to be light-cured. The window panel 100 may be, for example, a transparent glass substrate exposed outwardly from a display device to display an image. The object to be light-cured may be different in another embodiment. Each of the first to fourth LED rails 210, 220, 230 and 240 includes one or more LEDs, and may be arranged in outer peripheral regions adjacent to respective sides of the window panel 100 to provide light to the window panel 100.

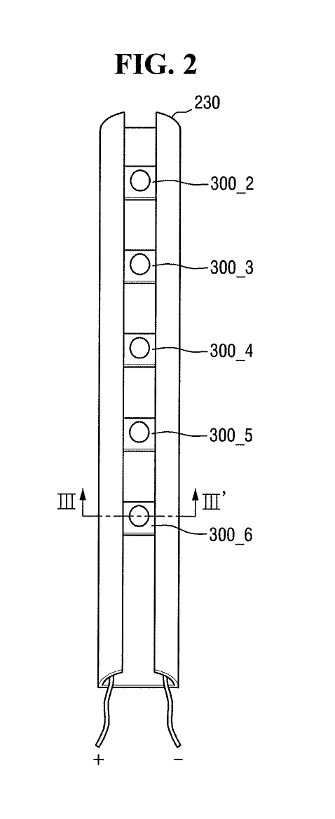

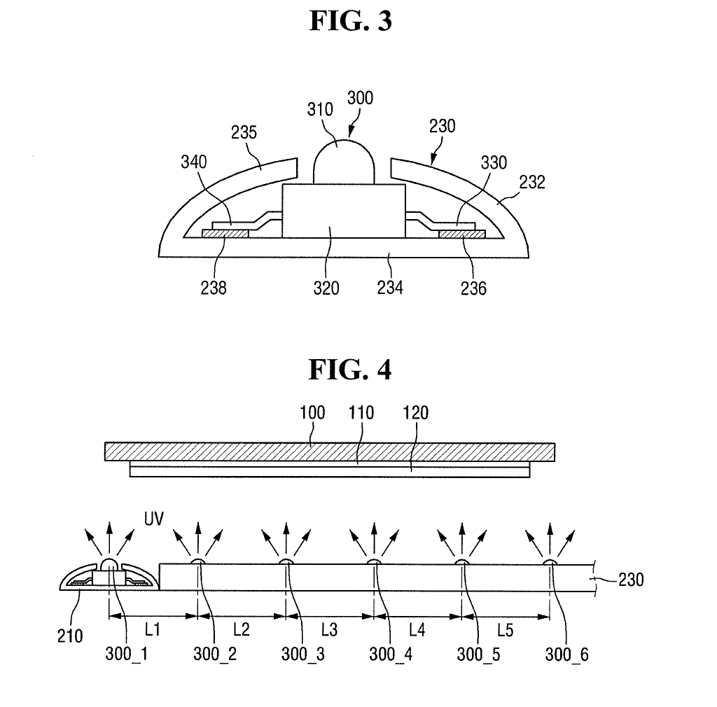

FIG. 2 is a three-dimensional view of an embodiment of the third LED rail 230 in FIG. 1, and FIG. 3 is a cross-sectional view of the LED rail 230 taken along the line of FIG. 2.

Referring to FIGS. 2 and 3, the LED rail 230 includes a rail body 235, a first electrode 236 and a second electrode 238 within the rail body, and a plurality of LEDs 300 in the rail body. The rail body includes a lower plate 234, and upper lids 232 extending toward a center directly above the lower plate 234 from respective ends of the lower plate 234. The upper lids 232 may form a slit, for example, at a center position directly above the lower plate 234.

The third LED rail 230 includes a first electrode 236 and a second electrode 238 within the sides of the rail body in a width direction of the rail body. The first electrode 236 and the second electrode 238 may be extended in a lengthwise direction of the rail body, and may be connected to LEDs 300_2 to 300_6 of the third LED rail 230 in parallel with each other. The first electrode 236 and the second electrode 238 may extend outwardly in the lengthwise direction of the rail body and connected to the respective positive (+) and negative (−) direct current voltage sources.

The LEDs 300 in each LED rail may be substantially the same. To discriminate among the LEDs in the third LED rail 230 and a single LED in the first LED rail 210 in FIG. 2, and later in FIG. 4, the LEDs in the third LED rail 230 are denoted as reference numerals “300_2”, “300_3”, “300_4”, “300_5” and “300_6” and the single LED in the first LEI) rail 210 is denoted as a reference numeral “300_1”.

FIG. 3 illustrates an embodiment of a surface mounted LED which may correspond to the LEDs 300. Referring to FIG. 3, the LED 300 includes an LED body 320, a lens 310 arranged on the LED body 320, and a first lead frame 330 and a second lead frame 340 extending outwardly from the LED body 320.

The LED body 320 may be supported by the lower plate 234 and the upper lids 232 of the rail body, and may be guided by the rail body such that the LED body 320 is movable in the lengthwise direction of the LED rail 230.

The LED lens 310 may be exposed outwardly from the rail body through the slit formed by the upper lids 232 of the rail body, and may emit light outwardly having a wavelength corresponding to unique features of LEDs.

The first lead frame 330 and the second lead frame 340 may penetrate into the LED body 320 and electrically connected to the respective light emitting bodies within the LED body 320. Furthermore, the first lead frame 330 and the second lead frame 340 may extend outwardly from the LED body 320 and connected to the respective first electrode 236 and second electrode 238. For example, the LED may be electrically connected to the first electrode 236 and the second electrode 238 through the first lead frame 330 and the second lead frame 340.

The first lead frame 330 and the second lead frame 340 may slidably contact the first electrode 236 and the second electrode 238, respectively. This allows an electrical connection to be formed and maintained between the first electrode 236 and the first lead frame 330 and an electrical connection to be formed and maintained between the second electrode 238 and the second lead frame 340, even when the LED 300 moves in the lengthwise direction of the rail body within the rail body.

The expression “slidably contact” as used herein may include a state where the positions of at least two components vary by external force when the two components are in contact with each other, and/or may include a contact state not fixed by an adhesive, external fixing means, or the like.

In one embodiment, since the LED 300 in the rail body moves in the lengthwise direction of the rail body while maintaining electrical connection with the first electrode 236 and the second electrode 238, a spacing between the plurality of LEDs 300 in the LED rail may be adjusted. For example, when an object to be light-cured requires a greater quantity of light for curing, additional LEDs may be inserted into the rail body to increase the number of LEDs in the LED rail 230, and spacing between LEDs may be narrowed. Thus, the spacing between LEDs is narrowed to increase the quantity of light per unit area or per unit length incident on the object to be light-cured.

As another example of providing a greater quantity of light to an object to be light-cured, LEDs of a relatively lower capacity may be removed from the rail body of the LED rail and high capacity LEDs may be inserted into the rail body. Thus, the quantity of light per unit area or per unit length incident on the object to be light-cured may be increased.

In another embodiment, the spacing between the LEDs in the LED rail may be widened or the LEDs may be replaced by LEDs of a relatively lower capacity, so as to reduce the quantity of light incident on the object to be light-cured.

In one embodiment, when the object to be light-cured includes an ultraviolet curable agent, the LEDs 300 may be ultraviolet LEDs which emit light of an ultraviolet wavelength region. If a material of the object to be light-cured is changed, the LEDs 300 may be replaced by LEDs which emit light having a corresponding (e.g., different) wavelength. Also, an LED which is damaged or deteriorated may be replaced by another LED, thereby lengthening the useful life of the LED rail as an LED light source.

FIG. 4 is a left side embodiment of the light curing apparatus in FIG. 1. This view shows the window panel 100, a display panel 120, and a light curable agent 110 between the display panel 120 and the window panel 100. In FIG. 4, an ultraviolet curable material is provided as an example of the light curable agent 110. The ultraviolet curable material may serve to maintain adhesion between, and thus seal a gap between, the window panel 100 and the display panel 120. Such an arrangement may prevent air from permeating into the gap.

Referring to FIG. 4, part of the first LED rail 210 and the third LED rail 230 may be arranged in the vicinity of one side of the window panel 100 which has a tetragonal shape overall.

One single LED 300_1 of the first LED rail 210 and the LEDs 300_2 to 300_6 of the third LED rail 230 may provide ultraviolet rays to the ultraviolet curable material between the window panel 100 and the display panel 120. Distances L1 to L5 between LEDs 300_1 to 300_6 may be adjusted to control the quantity of ultraviolet light per unit area or per unit length provided to the ultraviolet curable material, and to make the distribution of the quantity of ultraviolet light provided to the ultraviolet curable material to be uniform. If each of LEDs 300_1 to 300_6 emits the same quantity of light, distances L1 to L5 between LEDs 300_1 to 300_6 may also be the same. In another embodiment, the distances may be different.

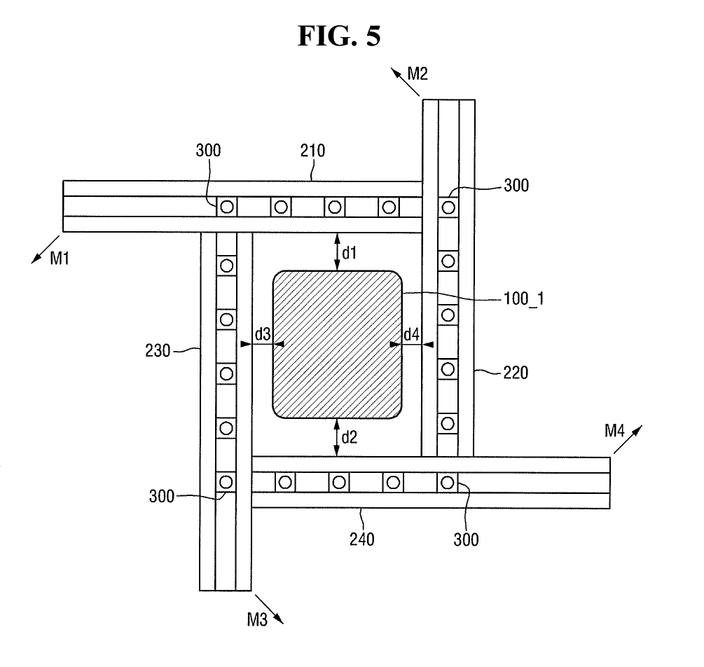

FIG. 5 to FIG. 7 illustrates an embodiment of a method for changing the positions of the first to fourth LED rails 210, 220, 230 and 240 and for adjusting the spacing between the LEDs 300 in the light curing apparatus. This embodiment may be applied, for example, when the size of the object to be light-cured is reduced or under other circumstances.

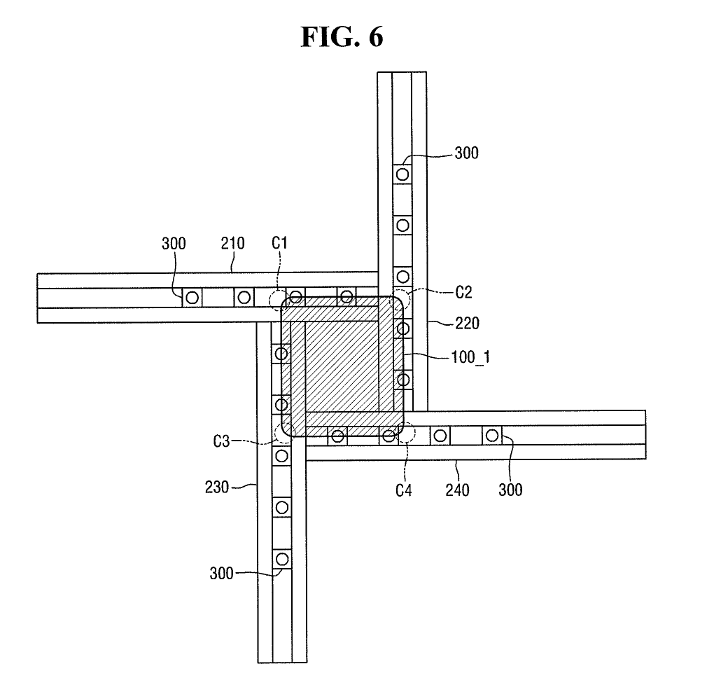

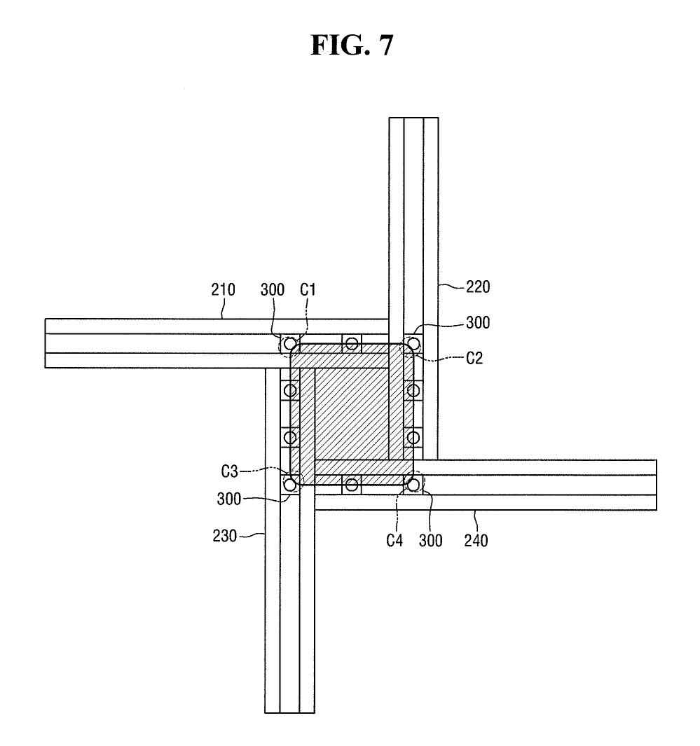

FIG. 5 is a top view illustrating both the light curing apparatus including the first to fourth LED rails and an object to be light-cured having a relatively smaller size than the object to be light-cured in FIG. 1. FIG. 6 is a top view illustrating an embodiment of the light curing apparatus in which the position of each LED rail in FIG. 5 is changed according to the size of an object to be light-cured. FIG. 7 is a top view of the light curing apparatus in which the spacing between adjacent LEDs of each LED rail in FIG. 6 is adjusted.

Referring to FIG. 5, a window panel 100_1 is provided having a relatively smaller size than the window panel in FIG. 1. The first to fourth LED rails 210, 220, 230, and 240 may be arranged at the respective four sides of the smaller window panel 100_1, such that the first to fourth LED rails 210, 220, 230, and 240 are spaced apart from the four sides of the window panel 100_1.

The first LED rail 210 may move in a first direction M1, the second LED rail 220 may move in a second direction M2, the third LED rail 230 may move in a third direction M3, and the fourth LED rail 240 may move in a fourth direction M4 in correspondence to the size of the smaller window panel 100_1, which is the object to be light-cured.

For example, the distance between the first LED rail 210 and an upper side of the smaller window panel 100_1 is first spacing d1, the distance between the fourth LED rail 240 and a lower side of the smaller window panel 100_1 is second spacing d2, the distance between the third LED rail 230 and a left side of the smaller window panel 100_1 is third spacing d3, and the distance between the second LED rail 220 and a right side of the smaller window panel 100_1 is fourth spacing d4. In this case, the first LED rail 210 may have one end movable downwardly in a vertical direction by the first spacing d1 and movable left in parallel in a horizontal direction by the fourth spacing d4.

Furthermore, the second LED rail 220 may move upwardly in a vertical direction by the second spacing d2, and move left in parallel in a horizontal direction by the fourth spacing d4.

Furthermore, the third LED rail 230 may move downwardly in a vertical direction by the first spacing d1, and move right in parallel in a horizontal direction by the third spacing d3.

Furthermore, the fourth LED rail 240 may move upwardly in a vertical direction by the second spacing d2, and move right in parallel in a horizontal direction by the third spacing d3.

FIG. 6 illustrates an example in which the first to fourth LED rails 210, 220, 230, and 240 are moved and located such that the LEDs 300 are arranged along the four sides of the smaller window panel 100_1. Referring to FIG. 6, the LEDs 300 are arranged adjacent to the four sides of the smaller window panel 100_1 with movement of the first to fourth LED rails 210, 220, 230, and 240. However, since the spacing between the adjacent ones of LEDs 300 in each LED rail 210, 220, 230, and 240 may not move, the arrangement relationship between the LEDs adjacent to each side of the smaller window panel 100_1 and each side of the smaller window panel 100_1 may differ, among the four sides of the smaller window panel 100_1.

For example, the number of and distance between LEDs provided adjacent to each corner C1 to C4 of the smaller window panel 100_1 may differ among the corners C1 to C4. Accordingly, the distribution of the quantity of light incident on the smaller window panel 100_1 to be light-cured or on a curable material may differ among the four sides of the smaller window panel 100_1. Thus, the quantity of light provided to a portion of the four corners C1 to C4 may not be sufficient for light curing.

The above-described difficulties may result from fixing the spacing between the LEDs that are used as a light source for the light curing apparatus. For example, when an LED bar-shaped light source is used having the LEDs 300 fixed on a printed circuit board in the light curing apparatus, the LED bar-shaped light source may not emit a sufficient quantity of light, when the size of the window panel 100 to be light-cured is changed, at least at the corners of the window panel 100 having the changed size.

Referring to FIG. 7, in accordance with one embodiment, the LEDs 300 may move in the lengthwise direction of the first to fourth LED rails 210, 220, 230, and 240. As a result, the LEDs 300 may be arranged to emit a uniform quantity of light to the regions adjacent to the four sides of the smaller window panel 100_1 and to the regions adjacent to the four corners of the smaller window panel 100_1.

For example, a single LED may be arranged at each corner C1 to C4 of the smaller window panel 100_1, and the spacing between the LEDs 300 in the first to fourth LED rails 210, 220, 230, and 240 may be adjusted to be the same.

Furthermore, surplus LEDs which are not used in light-curing the smaller window panel 100_1 may be removed from the first to fourth LED rails 210, 220, 230, and 240, thereby reducing waste of power caused by operation of unnecessary LEDs. Furthermore, the removed LEDs may be re-used later, thereby lengthening the useful life of the LED rails and the light curing apparatus.

If the size of the window panel 100 to be light-cured is increased, the first to fourth LED rails 210, 220, 230, and 240 may move to correspond to four sides of the larger window panel 100, and additional LEDs may be inserted into each of the first to fourth rails to provide a sufficient quantity of light.

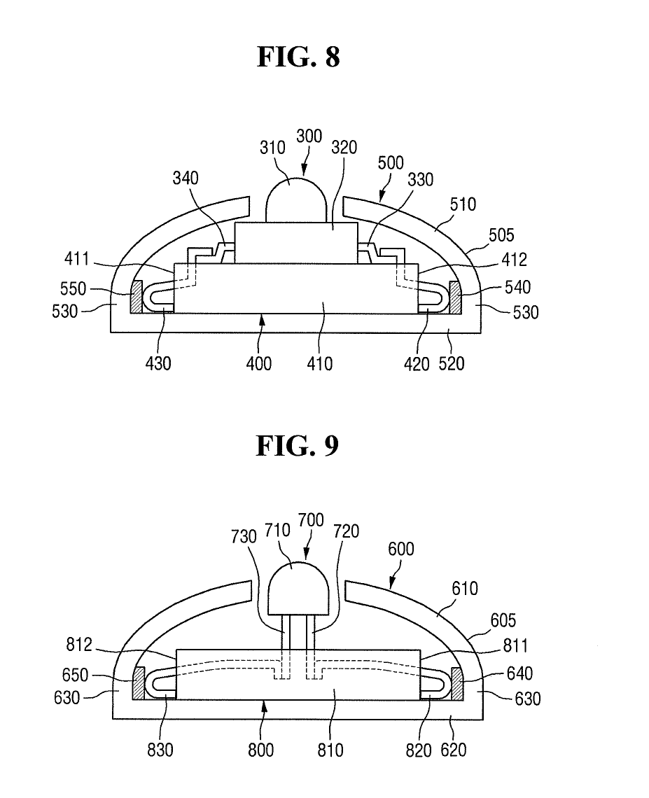

FIG. 8 is illustrates a cross-sectional view of another embodiment of an LED rail 500. Referring to FIG. 8, the LED rail 500 includes a rail body 505, a first electrode 540 and a second electrode 550 arranged within the rail body, an LED support unit 400 inserted into the rail body and electrically connected to the first electrode 540 and the second electrode 550, and an LED 300 mounted on the LED support unit 400 and inserted in the rail body.

The rail body 505 includes a lower plate 520, side walls 530 formed at respective ends of the lower plate 520, and upper lids 510 extending from the side walls 530 toward a center directly above the lower plate 520. The upper lids 510 may form a slit in the center directly above the lower plate 520.

The first electrode 540 and the second electrode 550 are arranged on respective sidewalls 530 of the rail body 505 facing each other, and extend in the lengthwise direction of the LED rail 500.

The LED support unit 400 includes a support body 410, a first connecting conductive wire 420, and a second connecting conductive wire 430. The first connecting conductive wire 420 and the second connecting conductive wire 430 penetrate through respective side walls 412 and 411 of the support body 410, which face the respective side walls 530 of the rail body 505. The first connecting conductive wire 420 and the second connecting conductive wire 430 pass through the support body 410 and penetrate through an upper surface of the support body 410 to protrude outwardly.

The LED 300 may be mounted on the upper surface of the support body 410 of the LED support unit 400, supported by the upper surface of the support body 410 and the upper lids 510, and guided by the LED support unit 400 and the upper lids 510. As a result, the LED 300 is movable in the lengthwise direction of the LED rail.

The first lead frame 330 and the second lead frame 340 of the LED 300 may be electrically connected to the first connecting conductive wire 420 and the second connecting conductive wire 430, respectively. The first connecting conductive wire 420 and the second connecting conductive wire 430 may be in tight contact with the first lead frame 330 and the second lead frame 340, respectively, to restrict movement of the LED on the support body 410.

The first connecting conductive wire 420 and the second connecting conductive wire 430 protrude outwardly after penetrating through the respective side walls 412 and 411 of the support body 410, and are electrically connected to respective ones of first electrode 540 and second electrode 550. The first connecting conductive wire 420 and the second connecting conductive wire 430 slidably contact the first electrode 540 and the second electrode 550, respectively. As a result, electrical connection between the first electrode 540 and the first connecting conductive wire 420 and electrical connection between the second electrode 550 and the second connecting conductive wire 430 may be maintained even when the LED 300 and the LED support unit 400 move in the lengthwise direction of the rail body 505 within the rail body 505.

Furthermore, the first connecting conductive wire 420 and the second connecting conductive wire 430, which protrude outwardly after penetrating through the respective side walls 412 and 411 of the support body 410, may be curved into a predetermined (e.g., U-shape), and may function, for example, as a U-shaped spring for supporting horizontal movement of the support body 410 between the first electrode 540 and the second electrode 550.

For example, the first connecting conductive wire 420 and the second connecting conductive wire 430, which protrude outwardly after penetrating through the respective side walls 412 and 411 of the support body 410, may have a U-plate spring shape and may be slidably connected to the respective first electrode 540 and second electrode 550, to support horizontal movement of the support body 410 and to maintain electrical connection with the first electrode 540 and the second electrode 550 in the LED rail 500.

FIG. 9 is a cross-sectional view of another embodiment of a LED rail 600 which includes a rail body 605, a first electrode 640 and a second electrode 650 arranged within the rail body 605, an LED support unit 800 in the rail body 605 and electrically connected to the first electrode 640 and the second electrode 650, and an LED 700 mounted on the LED support unit 800 and inserted in the rail body 605.

The rail body 605 includes a lower plate 620, side walls 630 formed at respective ends of the lower plate 620, and upper lids 610 extending from the side walls 630 toward a center directly above the lower plate 620. The upper lids 610 may form a slit in the center directly above the lower plate 620. Furthermore, the first electrode 640 and the second electrode 650 may be arranged on the two sidewalls 630 of the rail body 605 facing each other, respectively.

The LED support unit 800 includes a support body 810, a first connecting conductive wire 820, and a second connecting conductive wire 830. The first connecting conductive wire 820 and the second connecting conductive wire 830 penetrate through respective side walls 811 and 812 of the support body 810, which face respective side walls 630 of the rail body. The first and second connecting conductive wires 820 and 830 pass into the support body 810 and are electrically connected to the first lead frame 720 and the second lead frame 730, respectively, of the through-type LED 700 in support body 810.

The LED includes an LED lamp 710, a first lead frame 720, and a second lead frame 730. The LED lamp 710 is exposed outwardly through the slit in the rail body 605. The first lead frame 720 and the second lead frame 730 penetrate through respective holes in an upper surface of the support body 810, and are inserted into the support body 810 and electrically connected to the respective ones of the first connecting conductive wire 820 and second connecting conductive wire 830.

The first connecting conductive wire 820 and the second connecting conductive wire 830 protrude outwardly after penetrating through the respective side walls 811 and 812 of the support body 810, and are electrically connected to the respective ones of first electrode 640 and second electrode 650. In this case, the first connecting conductive wire 820 and the second connecting conductive wire 830 may slidably contact the first electrode 640 and the second electrode 650, respectively, so that electrical connection between the first electrode 640 and the first connecting conductive wire 820 and electrical connection between the second electrode 650 and the second connecting conductive wire 830 is maintained, even when the LED 700 and the LED support unit 800 move in the lengthwise direction of the rail body 605 within the rail body 605.

Furthermore, the first connecting conductive wire 820 and the second connecting conductive wire 830 which are protruded outwardly after penetrating through the respective side walls 811 and 812 of the support body 810 may be curved into a U-shape, and may function as a U-shaped spring for supporting the horizontal movement of the support body 810 between the first electrode 640 and the second electrode 650.

For example, the first connecting conductive wire 820 and the second connecting conductive wire 830, which protrude outwardly after penetrating through respective side walls 811 and 812 of the support body 810, may have a predetermined (e.g., U-plate spring) shape, and may be slidably connected to respective ones of the first electrode 640 and second electrode 650 to support the horizontal movement of the support body 810 and to maintain electrical connection with the first electrode 640 and the second electrode 650 within the LED rail 600.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A light emitting diode (LED) rail, comprising:
a rail body;
a first electrode and a second electrode within the rail body; and
a plurality of LEDs in the rail body and electrically connected to the first electrode and the second electrode, wherein the LEDs include a first lead frame and a second lead frame and wherein the first lead frame and the second lead frame slidably contact the first electrode and the second electrode, respectively.

2. The LED rail as claimed in claim 1, wherein the rail body includes:
a lower plate, and
upper lids extending toward a center position above the lower plate, the upper lids extending from respective ends of the lower plate, the upper lids spaced to form a slit substantially at the center position above the lower plate.

3. The LED rail as claimed in claim 2, wherein the LEDs are supported by the lower plate and the upper lids of the rail body and are guided by the rail body, the LEDs to move in a lengthwise direction of the LED rail.

4. The LED rail as claimed in claim 3, wherein the LEDs are to move in the lengthwise direction of the LED rail while maintaining an electrical connection between the first electrode and the first lead frame and an electrical connection between the second electrode and the second lead frame.

5. The LED rail as claimed in claim 1, wherein the LEDs are to emit light in an ultraviolet range.

6. The LED rail as claimed in claim 1, wherein the first electrode and the second electrode are at respective sides of the rail body in a width direction of the rail body and extend in a lengthwise direction of the rail body.

7. The LED rail as claimed in claim 6, wherein the LEDs are electrically connected to the first electrode and the second electrode in parallel with each other.

8. A light emitting device (LED) rail, comprising:
a rail body;
a first electrode and a second electrode within the rail body;
a plurality of LED supports in the rail body and electrically connected to the first electrode and the second electrode; and
a plurality of LEDs on respective ones of the LED supports and inserted in the rail body, wherein the LEDs include a first lead frame and a second lead frame, wherein the LED supports include a first connecting conductive wire and a second connecting conductive wire, and wherein the first lead frame slidably contacts the first electrode through the first connecting conductive wire and the second lead frame slidably contacts the second electrode through the second connecting conductive wire.

9. The LED rail as claimed in claim 8, wherein the rail body includes:
a lower plate.
side walls at respective ends of the lower plate, and
upper lids extending from respective ones of the sidewalls toward a center position above the lower plate, the upper lids spaced to form a slit substantially at the center position above the lower plate.

10. The LED rail as claimed in claim 9, wherein the LEDs and the LED supports are guided by the rail body and wherein the LEDs and the LED supports are to move in a lengthwise direction of the LED rail.

11. The LED rail as claimed in claim 10, wherein the LEDs and the LED supports are to move in the lengthwise direction of the LED rail while an electrical connection is maintained between the first electrode and the first connecting conductive wire and an electrical connection is maintained between the second electrode and the second connecting conductive wire.

12. The LED rail as claimed in claim 9, wherein:
the first connecting conductive wire and the second connecting conductive wire protrude outwardly after penetrating through respective side walls of a support body, and
each of the first connecting conductive wire and the second connecting conductive wire are curved to have a bent shape.

13. The LED rail as claimed in claim 8, wherein the first electrode and the second electrode are at respective side walls of the rail body facing each other and extend in a lengthwise direction of the rail body.

14. The LED rail as claimed in claim 8, wherein the LEDs are to emit light in an ultraviolet range.

15. A light curing apparatus, comprising:
a plurality of light emitting devices (LEDs); and
one or more LED rails, wherein the one or more LED rails include the LEDs and wherein the LEDs are to move in a lengthwise direction of the LED rails.

16. The apparatus as claimed in claim 15, wherein the one or more LEDs are removably mounted in each of the one or more LED rails.

17. The apparatus as claimed in claim 15, wherein the one or more LEDs in each of the LED rails are to change position to accommodate an additional LED.

18. The apparatus as claimed in claim 15, wherein the LED rails are to move to a position adjacent to at least one side of an object to be light-cured the position based on a size of the object to be light-cured.
